(19) United States
(12) Patent Application Publication
(10) Pub. No.: US 2002/0159831 A1
(43) Pub. Date: Oct. 31, 2002

(54) Clip for a fabric treatment apparatus

(76) Inventor: Hugh Williamson, Lancaster, OH (US)

Correspondence Address: Daniel A. Thomson, One Cascade Plaza, Fourteenth Floor, Akron, OH, 44308-1381, US

(21) Appl. No.: 09/843,966

(22) Filed: Apr. 27, 2001

(51) Int. Cl. B25G 3/36; E04G 7/00

(52) U.S. Cl. 403/397

(57) ABSTRACT

A clip for aligning a top portion and bottom portion of a fabric treatment apparatus comprises a clip body having a rear engaging portion and a front engaging portion. The rear engaging portion is made to receive an associated bottom slot edge found in the bottom portion of the fabric treatment apparatus. The front engaging portion is capable of receiving, substantially simultaneously, a second bottom slot edge, which opposes a first bottom slot edge, and a top slot edge located in the top portion of the fabric treatment apparatus. The clip further comprises an alignment tab communicating with the front engaging portion in at least two locations, such that the top portion and bottom portion of the fabric treatment apparatus are operatively aligned and a side-to-side relationship between the same is maintained.

### BACKGROUND OF THE INVENTION

A. Field of Invention

The present invention relates to a clip used for aligning a top portion and bottom portion of a fabric treatment apparatus. The clip may be used on any apparatus which requires alignment and connection of two portions, whether a top and bottom portion or side by side portions.

B. Description of the Related Art

Fabric treatment apparatuses, namely washing machines and dryers, typically include a bottom cabinet and a separate top portion. The bottom cabinet contains the rotatable tub for clothes, while the top portion may comprise the lid. Similarly, clothes dryers also have top and bottom portions, which are similar in configuration to a washing machine.

Currently, a clip is used to secure the top and bottom portions of a fabric treatment apparatus together. These clips also function to align the top and bottom portions. As shown in FIGS. 1-1g, a clip 5 fits through slots defined in the top and bottom portions. This is performed by compressing the clip and then releasing the same to securely fit the two portions of the fabric treatment apparatus together. Then, with this clip assembly, an additional securing device 8, such as an alignment pin, is needed to properly align the top and bottom portions of the apparatus. This leads to additional cost and expense during assembly. A need in the art exists for a single clip that is capable of keeping the top and bottom portions of a fabric treatment apparatus in proper alignment and to maintain the side-by-side relationship thereof without the use of a separate alignment device.

### SUMMARY OF THE INVENTION

The present invention provides a clip for aligning a top portion and a bottom portion of a fabric treatment apparatus. The clip comprises a clip body having a rear engaging portion and a front engaging portion. The rear engaging portion is made to receive an associated bottom slot edge found in the bottom portion of the fabric treatment apparatus. The front engaging portion is capable of receiving, substantially simultaneously, a second bottom slot edge, which opposes a first bottom slot edge, and a top slot edge located in the top portion of the fabric treatment apparatus. The clip further comprises an alignment tab communicating with the front engaging portion in at least two locations, such that the top portion and bottom portion of the fabric treatment apparatus are operatively aligned and a side-to-side relationship between the same is maintained.

Accordingly, it is an object of the present invention to provide a clip, which provides alignment between a top and bottom portion of a fabric treatment apparatus without the use of a secondary or separate device.

Another object of the present invention is to provide a clip having a front engaging portion that comprises an upper angled portion and a lower flanged portion.

Still yet another object of the present invention is to provide a clip, wherein the alignment tab extends from the upper portion of the front engaging portion to the lower portion and extends past the lower portion.

Further, another object of the present invention is to provide a clip having a clip body with a first side and second side, wherein the first and second sides are interconnected by a bight portion (“bight” is intended to encompass a bend of any kind in any material).

Another object of the present invention is to provide a clip, wherein a bight portion angle of the clip body is substantially 65°.

Still yet another object of the present invention is to provide a clip, wherein the angled portion of the front engaging portion further comprises a free distal end being arcuately shaped.

Yet another object of the present invention is to provide a clip, wherein the flange portion of the front engaging portion also has a free distal end being arcuately shaped.

Further, another object of the present invention is to provide a clip, wherein the front engaging portion is substantially U-shaped.

Another object of the present invention is to provide a clip, wherein the rear engaging portion is substantially U-shaped.

Still yet another object of the present invention is to provide a clip, wherein the clip body and the upper portion of the front engaging portion form a substantially triangular shape.

Yet, another object of the present invention is to provide a clip to be used on a washing machine.

Another object of the present invention is to provide a clip that is suitable for use with a clothes dryer.

Further, another object of the present invention is to provide a clip, wherein the clip body is semi-rigid, such that it may be slightly compressed to properly connect and align the top and bottom portions of a fabric treatment apparatus.

Yet another object of the present invention is to provide a clip that is easy and economical to manufacture.

Still other benefits and advantages of the invention will become apparent to those skilled in the art to which it pertains, upon a reading and understanding of the following detailed specifications.

### BRIEF DESCRIPTION OF THE DRAWINGS

The invention may take physical form in certain parts and arrangement of parts, one embodiment of which will be described in detail in this specification and illustrated in the accompanying drawings, which form a part hereof and wherein:

FIG. 1 is a side elevational view of the prior art;

FIG. 1a is a top view of the bottom portion slot of the prior art;

FIG. 1b is a top view of the top portion slot of the prior art;

FIG. 1c is a left side elevational view of the prior art;

FIG. 1d is a bottom perspective view of the prior art;

FIG. 1e is a right side view of the prior art;

FIG. 1f is a top view of a fabric treatment apparatus utilizing a clip known in the art and a separate securing device;

FIG. 1g is a cross-sectional view of a fabric treatment apparatus utilizing a clip known in the art and a separate securing device;

FIG. 2 is a perspective view of the present invention;

FIG. 3 is a front elevational view of the present invention;

FIG. 4 is an elevational view of the present invention securely attached to the fabric treatment apparatus;

FIG. 4a is a top view of the top portion showing the top portion slot;

FIG. 4b is a top view of the bottom portion showing the bottom portion slot;

FIG. 4c is a perspective view of the present invention positioned in the top and bottom positions of the fabric treatment apparatus;

FIG. 5 is a side view of the present invention taken along line 5-5 of FIG. 3;

FIG. 6 is a cross-sectional view of the second embodiment of the present invention;

FIG. 7 is a top plan view of FIG. 6;

FIG. 8 is a front elevational view of the present invention taken along line 8—8 of FIG. 6;

FIG. 9 is a bottom view of FIG. 6;

FIG. 10 is a rear elevational view of the present invention taken along line 10—10 of FIG. 6;

FIG. 11 is a perspective view of FIG. 6;

FIG. 12 is a cross-sectional view of the third embodiment of the present invention;

FIG. 13 is a top view of FIG. 12;

FIG. 14 is a front elevational view of the present invention taken along lines 13-13 of FIG. 12;

FIG. 15 is a bottom view of FIG. 12; and,

FIG. 16 is a rear elevational view of the present invention taken along lines 15-15 of FIG. 12.

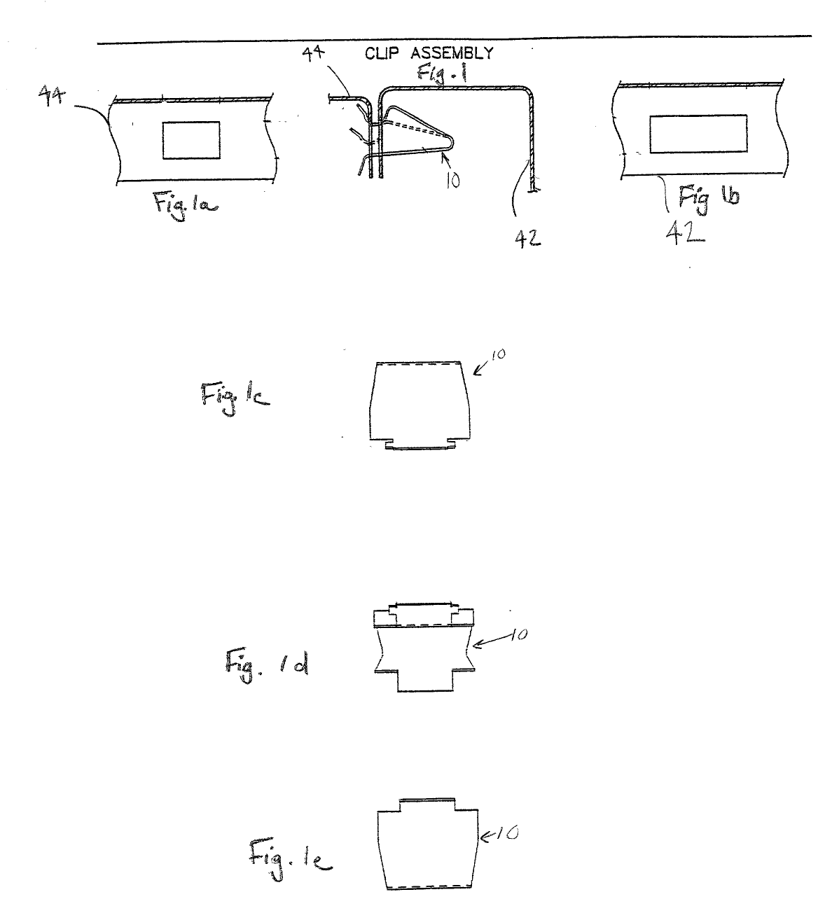

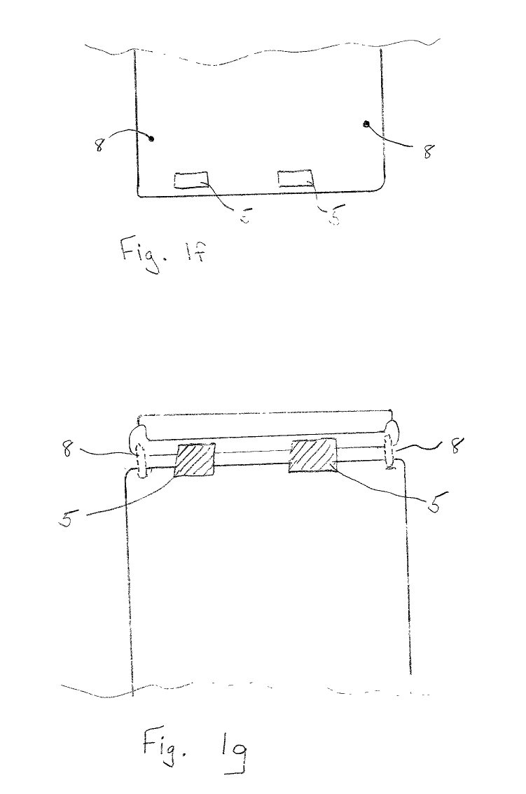

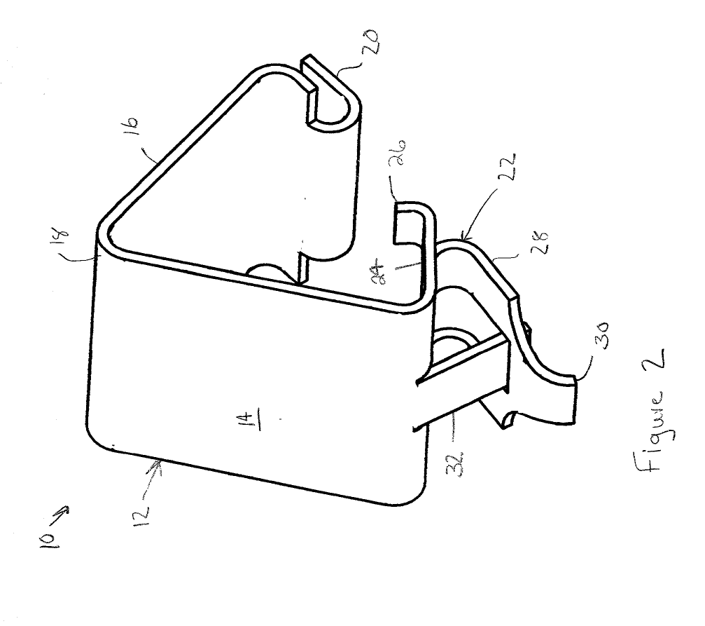

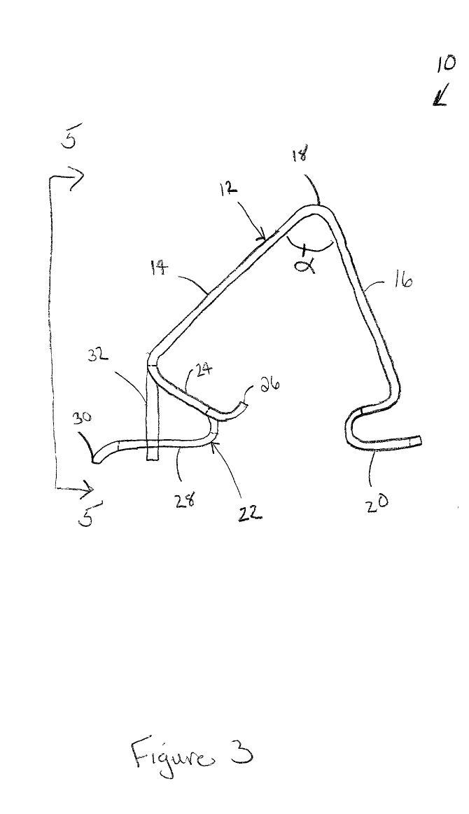

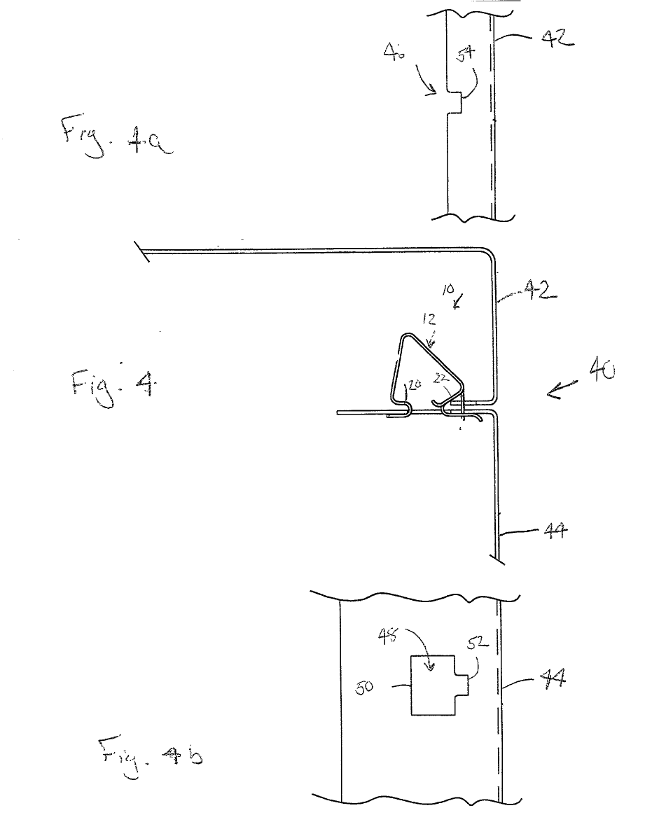

### DESCRIPTION OF THE INVENTION

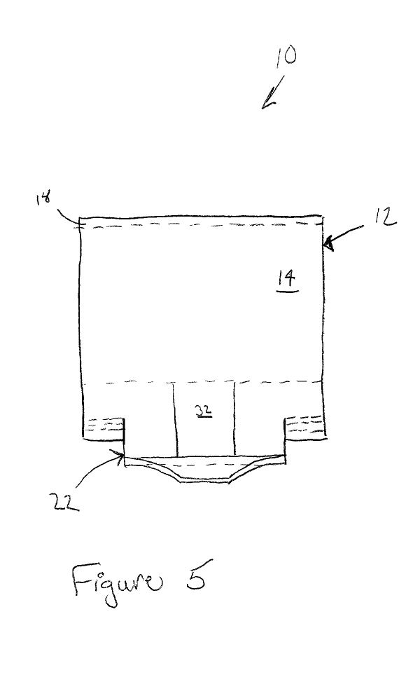

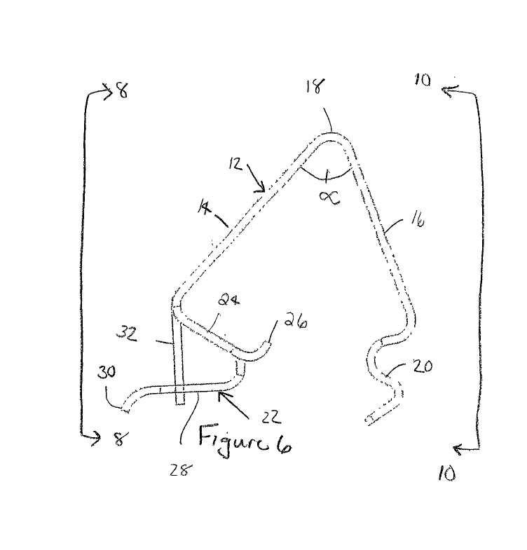

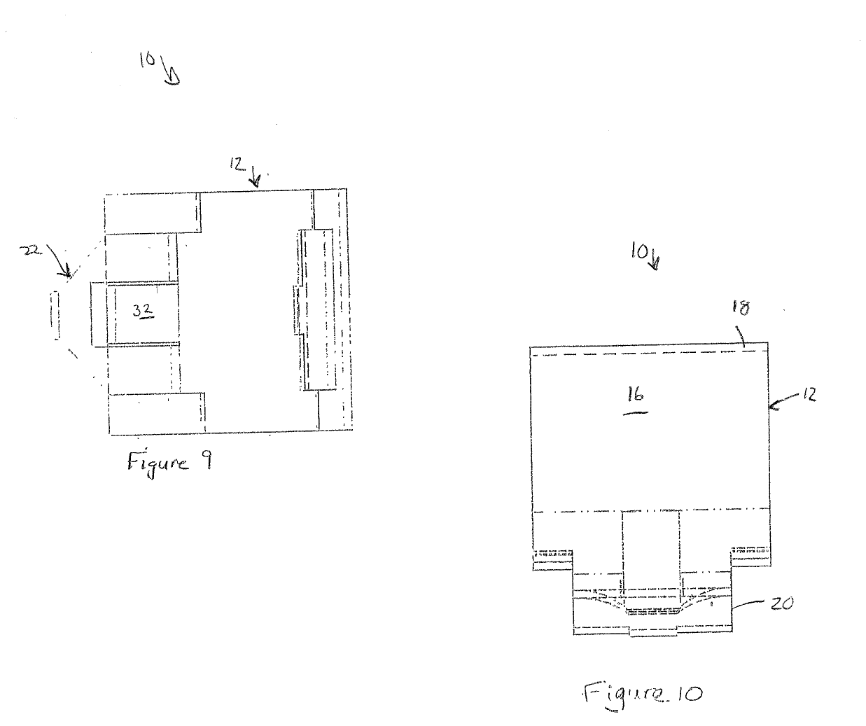

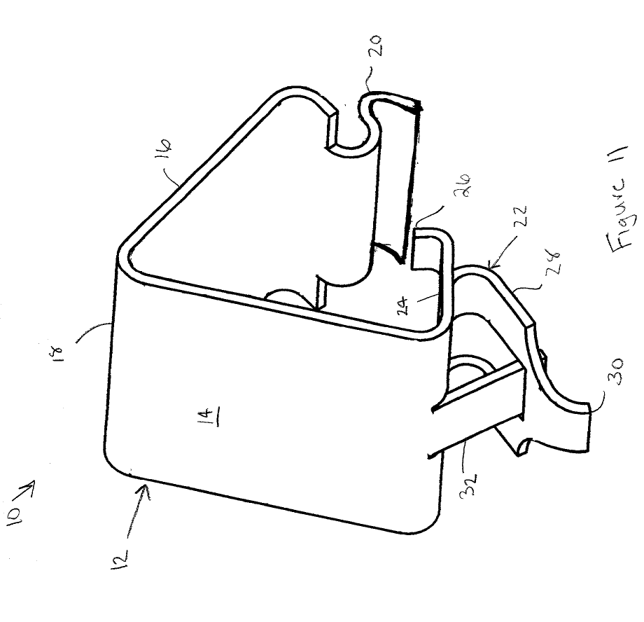

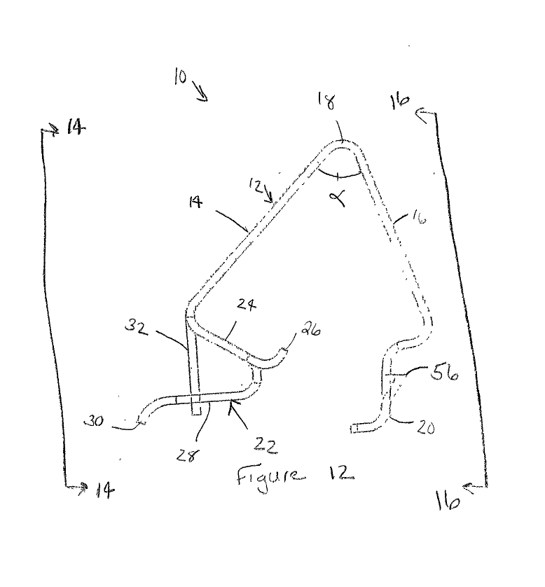

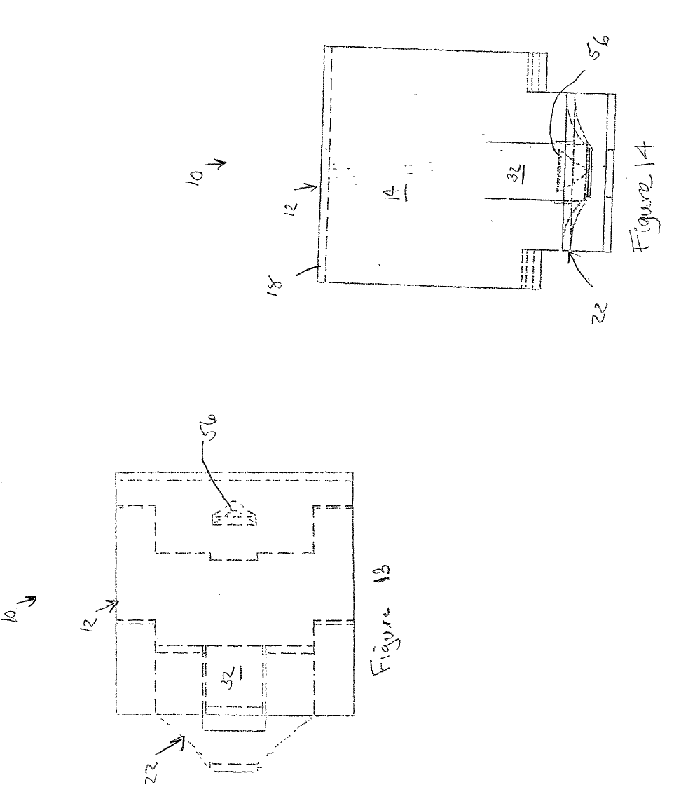

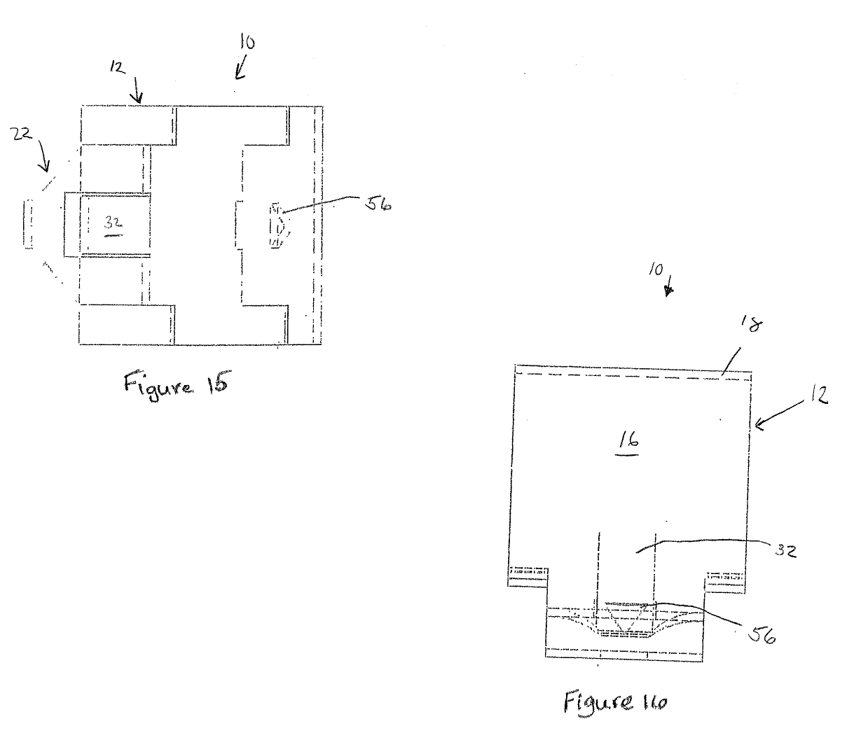

With reference now to FIGS. 2-16, a clip 10 for aligning a top portion 42 and bottom portion 44 of fabric treatment apparatus 40 is described. The clip 10 comprises a clip body 12 having a rear engaging portion 20, a front engaging portion 22, and an alignment tab 32. The alignment tab 32 communicates with the front engaging portion 22 in at least two locations such that the top portion 42 and bottom portion 44 of the fabric treatment apparatus 40 are operatively aligned and a side-to-side relationship between the top and bottom portions 42, 44 is maintained.

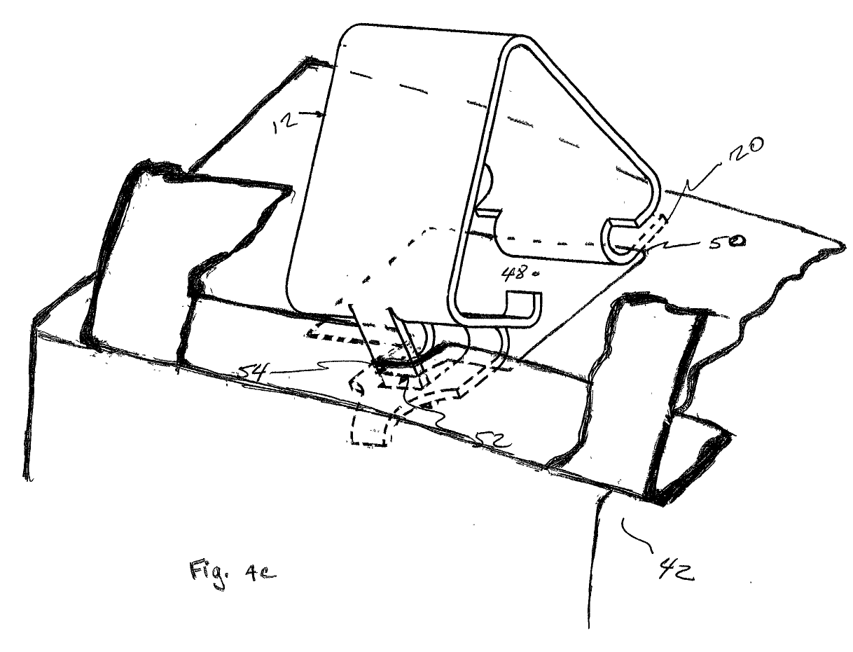

Generally, the present invention is utilized with fabric treatment apparatuses 40, including without limitation, washing machines and clothes dryers. Common characteristics of a fabric treatment apparatus include the top portion 42 and the bottom portion 44, which must be secured together in an operatively aligned relationship. The phrase “operatively aligned relationship” is intended to mean the alignment of portions of the fabric treatment apparatus 40, such that the fabric treatment apparatus 40 may serve its intended function. As shown in FIGS. 4, 4a, and 4b, a top slot 46 is defined in the top portion 42 and a second slot 48 is defined in the bottom portion 44. The slot 46 of the top portion 42 may be of any geometry chosen with sound engineering judgment. As shown in FIG. 3a, it is threesided, so as to form an engageable top portion slot edge 54. The slot 48 of the bottom portion 44 also may be of any geometry chosen with sound engineering judgment. As shown in FIG. 3b, the bottom slot 48 also forms bottom slot edges 50, 52. In this embodiment, the bottom slot edges 50, 52 are in an opposing relationship to each other. The top slot edge 54, bottom slot edge 50, and opposing bottom slot edge 52, may later be referred to as the first, second, and third slot edges 54, 50, 52, respectively. During assembly of the fabric treatment apparatus 40, the top and bottom slots 46, 48 align to form a passageway (shown, but not referenced) such that the clip 10 can pass therethrough and be secured into position.

With reference now to FIGS. 2-5, the clip 10 will be described in further detail. The clip body 12 has a first side 14 and a second side 16 interconnected by a bight portion 18. As shown in FIG. 3, the angle α of the bight portion 18 is approximately 65°. However, any angle may be utilized provided that the clip 10 can properly engage the top and bottom portions 42, 44 of the fabric treatment apparatus 40.

The front engaging portion 22 is capable of receiving at least a first slot edge 54. In this embodiment, as shown in FIG. 3, the front engaging portion 22 receives a first slot edge and a third slot edge, namely the second opposing bottom slot edge 52 and the top slot edge 54. The front engaging portion 22 also comprises an upper portion 24 and a lower portion 28, which generally form a U-shape. The upper portion 28 may be angled; however, this is not required. Any geometry for the clip body 12 may be used, as long as chosen using sound engineering judgment. The upper portion 24 of the front engaging portion 22 has an arcuately-shaped free distal end 26, which provides extra stability and strength during engagement of the top and bottom portions 42, 44 of the fabric treatment apparatus 40. The clip body 12 and the upper portion 24 of the front engaging portion 22 form a substantially triangular shape. The lower portion 28 of the front engaging portion also has a free distal end 30 that is arcuately shaped, The arcuate shape of the free distal end 30 of the lower portion 28 of the front engaging portion 22 aids in sliding the front engaging portion 22 onto the second bottom slot edge and top slot edge 52, 54.

The rear engaging portion 20 is also substantially U-shaped. The rear engaging portion 20 is made to receive the second slot edge 50. More specifically, as shown in FIG. 3, the rear engaging portion 20 receives the bottom slot edge 50. In this embodiment, the lower section 28 of the rear engaging portion 20 extends past the clip body 12 to ensure a more secure connection. This is also true for the front engaging portion 22. As shown in FIG. 3, the rear engaging portion 20 and front engaging portion 22 are interconnected through the first and second sides 14, 16 of the clip body 12 through the bight portion 18. Although this embodiment describes the front engaging portion 22 as receiving the top slot edge 54 and the opposing bottom slot edge 52, the clip 10 construction may be reversed such that the rear engaging portion 20 is capable of receiving the bottom slot edge 52 and top slot edge 54 and/or capable of comprising the alignment tab 32.

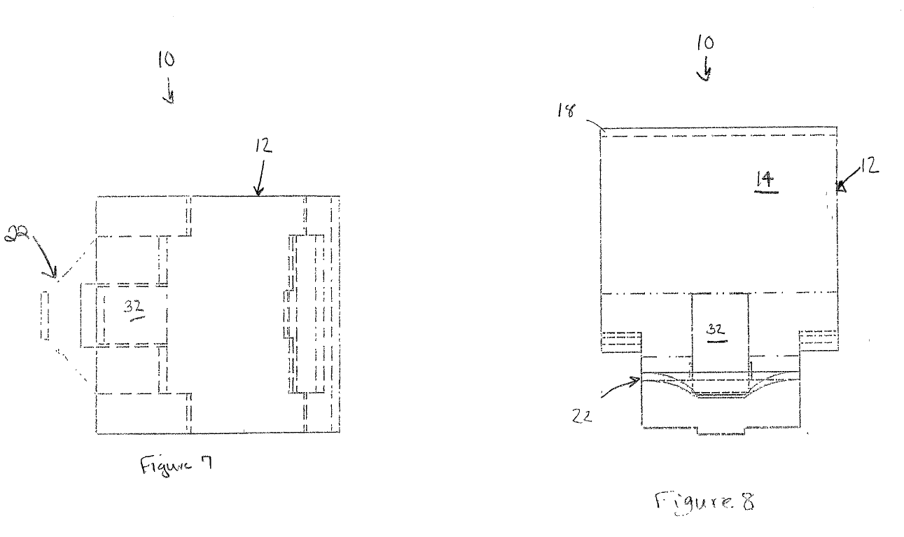

FIGS. 6-11 show a second embodiment of the present invention. The second embodiment of the present invention has generally the same configuration as previously described. However, the rear engaging portion 20, is slightly S-shaped for easily engaging the bottom slot edge 50. Turning now the FIGS. 12-16, a third embodiment of the present invention is shown. In this embodiment, the rear engaging portion 20 extends straight down in a substantially vertical position before being slightly upturned. The rear engaging portion may be at a slight angle relative to the point where the rear engaging portion 20 attaches to the second side 16. Attached to the rear engaging portion 20 is a triangular ledge 56. The triangular ledge 56 aids in support against the underside of the bottom slot edge 50. Although the ledge 56 is shown to be triangular in cross-section, the ledge 56 may be of any geometry.

Generally, the clip 10 may be constructed of one integral piece of material. Alternatively, different sections may be formed and then attached to arrive at the configuration shown in FIGS. 2-16. Various means of manufacturing the clip 10 may include, without limitation, injection molding, stamping, and cold-forming. Any other method, chosen with sound engineering judgment, may be used. The clip 10 may be made of a durable steel, metal, or other resilient material, such that it can be slightly compressed to fit into the slots 46, 48 of the top and bottom portions 42, 44 and, yet maintain its rigidity and maintain proper alignment of the top and bottom portions 42, 44.

When using the clip 10, the first and second sides 14, 16 of the clip body 12 are slightly compressed, so as to bring the front and rear engaging portions 20, 22 into close proximity. The clip 10 passes through the top and bottom slots 46, 48. The flanged lower portion 32 of the front engaging portion 22 slides under the second bottom slot edge 52 and simultaneously also engages the top slot edge 54. The rear engaging portion 20 slides into position thereby receiving the bottom slot edge 50. Due to the alignment tab 32, no further alignment or adjustment is necessary.

Although the present invention has been described in considerable detail with reference to certain embodiments thereof, other embodiments are possible. Therefore, the sphere and scope of the appended claims should not be limited to the description of the embodiments contained herein.

Having thus described the invention, it is now claimed:

What is claimed is:

1. A clip body, comprising:
a front engaging portion made to receive an associated first slot edge;
a rear engaging portion made to receive an associated second slot edge; and,
an alignment tab communicating with said front engaging portion in at least two locations.

2. The clip body of claim 1, wherein said front engaging portion is adapted to receive an associated third slot edge substantially simultaneously with the associated first slot edge.

3. The clip body of claim 1, wherein said front engaging portion further comprises an upper portion and a lower portion made to receive the associated first slot edge.

4. The clip body of claim 2, wherein said upper portion is angled.

5. The clip body of claim 2, wherein said alignment tab extends from said upper portion of said front engaging portion to said lower portion and extends past said lower portion.

6. The clip body of claim 1, wherein said front engaging portion and said rear engaging portion are interconnected by a first side and a second side of the clip body, said first side and said second side being interconnected by a bight portion.

7. The clip body of claim 6, wherein said bight portion has an angle of substantially 65 degrees.

8. The clip body of claim 2, wherein said upper portion of said front engaging portion further comprises a free distal end being arcuately shaped.

9. The clip body of claim 2, wherein said lower portion of said front engaging portion has a free distal end being arcuately shaped.

10. The clip body of claim 1, wherein said front engaging portion is substantially U-shaped.

11. The clip body of claim 1, wherein said rear engaging portion is substantially U-shaped.

12. The clip body of claim 1, wherein the rear engaging portion is substantially S-shaped.

13. The clip body of claim 1, wherein the rear engaging portion is substantially vertical relative to the point where the rear engaging portion attaches to a second side of the clip body.

14. The clip body of claim 13, further comprising a ledge attached to the rear engaging portion.

15. The clip body of claim 14, wherein said ledge is triangular.

16. A fabric treatment apparatus, comprising:
a top portion having a top slot defined therein, said top portion slot having at least a first slot edge;
a bottom portion having a bottom slot defined therein with at least a second slot edge and third opposing bottom slot edge; and,
a clip having a clip body, said clip body further comprising:
a rear engaging portion made to receive said second slot edge;
a front engaging portion made to receive said first slot edge; and,
an alignment tab communicating with said front engaging portion in at least two locations.

17. The fabric treatment apparatus of claim 16, wherein said front engaging portion further comprises an upper portion and a lower portion made to receive the first slot edge.

18. The fabric treatment apparatus of claim 17, wherein said upper portion is angled.

19. The fabric treatment apparatus of claim 17, wherein said front engaging portion is adapted to receive a third slot edge substantially simultaneously with said first slot edge.

20. The fabric treatment apparatus of claim 17, wherein said alignment tab extends from said upper portion of said front engaging portion to said lower portion and extends past said lower portion.

21. The fabric treatment apparatus of claim 20, wherein said front engaging portion and said rear engaging portion are interconnected by a first side and a second side of the clip body, said first side and said second side being interconnected by a bight portion.

22. The fabric treatment apparatus of claim 21, wherein said bight portion has an angle of substantially 65 degrees.

23. The fabric treatment apparatus of claim 17, wherein said upper portion of said front engaging portion further comprises a free distal end being arcuately shaped.

24. The fabric treatment apparatus of claim 17, wherein said lower portion of said flange portion has a free distal end being arcuately shaped.

25. The fabric treatment apparatus of claim 16, wherein said front engaging portion is substantially U-shaped.

26. The fabric treatment apparatus of claim 16, wherein said rear engaging portion is substantially U-shaped.

27. The fabric treatment apparatus of claim 16, wherein said fabric treatment apparatus is a washing machine.

28. The fabric treatment apparatus of claim 16, wherein said fabric treatment apparatus is a clothes dryer.

29. A method for aligning a top portion and bottom portion of a fabric treatment apparatus comprising the steps of:
providing a fabric treatment apparatus having a top portion, a bottom portion and a clip, said top portion having a top slot defined therein with at least one top slot edge, said bottom portion having a bottom slot defined therein with a first bottom slot edge and an opposing second bottom slot edge, said clip further comprising a clip body, a rear engaging portion, a front engaging portion, and an alignment tab, said rear engaging portion receiving said first bottom slot edge, said front engaging portion made to simultaneously receive said second opposing bottom slot edge and said top slot edge, said alignment tab communicating with said front engaging portion in at least two locations;
compressing said clip;
inserting said clip into through said top and bottom slots; and,
releasing said clip such that said rear engaging portion receives the first bottom slot edge and the front engaging portion simultaneously receives said second bottom slot edge and said top slot edge.

30. The method claim 29, wherein said front engaging portion further comprises an angled portion and a flange portion, said angled portion and flange portion each comprising a free distal end being arcuately shaped.

31. The method of claim 29, wherein said front engaging portion and said rear engaging portion are substantially U-shaped.

32. A fabric treatment apparatus, comprising:
a top portion having a top slot defined therein, said top portion slot having at least one top slot edge;
a bottom portion having a bottom slot defined therein with at least a first bottom slot edge and second opposing bottom slot edge; and,
a clip, said clip further comprising:
a compressible portion having a first side and a second side, said first side and said second side being interconnected by a bight portion, said bight portion having an angle of substantially 65 degrees;
a rear engaging portion communicating with said first side of said compressible portion and capable of receiving said first bottom slot edge, said rear engaging portion being substantially U-shaped;
a front engaging portion communicating with said second side of said compressible portion, said front engaging portion having an angled portion and capable of simultaneously receiving said second bottom slot edge and said top slot edge, said angled portion and said flange portion each having a free end being arcuately shaped, said front engaging portion being substantially U-shaped; and,
an alignment tab being operatively connected to said angled portion and said flange portion, said alignment tab extending from said angled portion of said front engaging portion to said lower portion and extends past said lower portion.
